(19) United States
(12) Patent Application Publication
(10) Pub. No.: US 2023/0216771 A1
(43) Pub. Date: Jul. 6, 2023

(54) ALGORITHM FOR BUILDING IN-CONTEXT REPORT DASHBOARDS

(71) Applicant: Virtual Instruments Worldwide, Inc., San Jose, CA (US)

(72) Inventors: Devin Blinn Avery, Madbury, NH (US); Valentin Vakar, San Jose, CA (US)

(73) Assignee: Virtual Instruments Worldwide, Inc., San Jose, CA (US)

(21) Appl. No.: 17/647,312

(22) Filed: Jan. 6, 2022

(51) Int. Cl. H04L 43/16; H04L 43/045; H04L 43/103; H04L 43/062

(52) U.S. Cl. CPC H04L 43/16; H04L 43/045; H04L 43/103; H04L 43/062

(57) ABSTRACT

An example system comprising one or more processors, memory containing instructions control one or more processors to receive network data from enterprise monitoring systems, each object being a digital device, virtual machine, virtual device, or application, analyze the network data to identify performance metric data related to objects of the enterprise system, performance metric data indicating performance of any number of objects in real time, receive a selection of an object identifier of an enterprise system, the object identifier identifying an object of the enterprise network, identify an object subset that includes the object identifier, the object subset including some objects of the enterprise network that are related by communication or performance of similar functions, if performance metrics from the network data for any objects in the object subset are performing outside of nominal thresholds, provide at least some performance metric data of those objects to the user interface.

### BACKGROUND

The complexity of enterprise networks has increased to a point where even information technology (IT) administrators may not be aware of entities of the enterprise network such as computing and storage resources which may need attention.

Enterprise networks consist of computing and storage resources designed to run business-related applications of an organization. Applications of the enterprise network, including for example, email service, web service, database, customer relationship management (CRM), data file, virtual desktop infrastructure (VDI), enterprise resource planning (ERP), and the like. Enterprise networks are increasingly moving towards a combination of on-premise and cloud-based infrastructure, making the ability to determine computing and storage resources associated with business-related applications more difficult. Each of the computing, storage resource, and applications of the enterprise network may have its own set of metrics that need to be monitored for the purposes of troubleshooting and the like.

It can be daunting for a monitoring system that monitors an enterprise network to provide useful information of a complex system to an IT administrator. Current monitoring systems often provide metrics associated with a particular entity of the enterprise network or metrics that a user has previously viewed. In one example, a graphical user interface, such as a user interface 1200 of FIG. 12, provides metrics associated with ethernet throughput. This information, however, does not often indicate what the IT administrator needs to assess a network problem.

One way for IT administrators to monitor aspects of the increasingly complex enterprise network is with assistance from a wide variety of standalone and integrated software tools available to aid in monitoring various aspects of the enterprise network. Each of the standalone or integrated software tools may capture data regarding different aspects of the enterprise network. For example, software to manage IP network traffic may provide data such as the speed of each hop from the router to a host but would not capture data regarding attributes of the host such as the operating system running on the host or central processing unit (CPU) usage of the host. Complex problems may require this information, however, the problem may involve many other aspects of the system to assist in determining the problems. As such, individual software tools that provide specific metrics are often insufficient.

Furthermore, data provided by different standalone or integrated software tools require viewing on their own platform. As such, information from various tools is separated and isolated from each other which makes it difficult to determine metrics that may be of importance or require attention from a user of the enterprise network. As a result, the prior art increases the difficulty of monitoring performance, health, and capacity of entities of the enterprise network (e.g., entities including applications, storage arrays, virtual machines, and the like).

Corporations demand acceptable levels of performance, reliability, redundancy, and security from their computing and storage devices. One way to achieve performance, reliability, and redundancy is to provide more resources than the computing environment would ever need. Unfortunately, the cost of information technology equipment, software, and personnel can be prohibitively expensive and runs contrary to an overall goal of an enterprise of profitability. Every corporation must strike a balance between the cost of additional computing and storage versus the performance, reliability, and redundancy benefits of the additional computing and storage resources.

In one example involving the difficulty of identifying the root of a problem, a user of the enterprise network complains of the slow response of the virtual desktop application of the enterprise network. The IT administrator may run a diagnostic, using storage performance monitoring tools, on one or more storage resources on which the VDI application is known to be running. The storage performance monitoring tool may determine that no storage performance problem exists. A common solution to the issue may be to increase the storage array capacity of the enterprise network, which may not result in an improvement in the response time of the storage array. The software integrated into routers of the enterprise network may not be able to pinpoint reasons for the slow response of the VDI application since this software would only have access data regarding traffic on the routers and not the performance of other entities of the VDI application connected to the routers. A performance management system, receiving metrics information from monitoring tools monitoring various aspects of the enterprise network, may determine a set of metrics that require the attention of the user of the performance management system, which may be an early indication of troubles with the enterprise network.

### SUMMARY

An example system comprising one or more processors, memory containing instructions configured to control the one or more processors to receive network data related to objects of an enterprise system, the network data being received from a plurality of enterprise monitoring systems, each object being a digital device, a virtual machine, virtual device, or application, analyze the received network data to identify performance metric data related to any number of objects of the enterprise system, the performance metric data indicating performance of the any number of objects in real time, receive, from a user interface, a selection of an object identifier of an enterprise system, the object identifier identifying a first object of the objects of the enterprise network, identify an object subset that includes the object identifier, the object subset including some objects of the enterprise network that are related to each other by communication or performance of similar functions, and if performance metrics from the network data for any of the objects in the object subset are performing outside of nominal thresholds, provide at least some performance metric data to the user interface regarding those objects in the object subset.

In some embodiments, the performance metric data includes performance information received from the enterprise monitoring system. In another example, the performance metric includes analysis of performance metric data received from the enterprise monitoring system. In various embodiments, when performance metrics from the network data for any of the objects in the object subset are performing outside of nominal thresholds comprises changes in metric parameters over time are outside of a nominal threshold. In one example, the performance metrics from the network data for any of the objects in the object subset includes an analysis of performance metrics, when a result of the analysis is performing outside of nominal threshold, provide at the result of the analysis to the user interface regarding the first object. The performance metrics performing outside of nominal thresholds may be two or more performance metrics for the same object of the enterprise network. In some embodiments, at least one of the nominal thresholds changes dynamically or may be received from the user interface. In some embodiments, if the performance metrics from the network data for all objects in the object subset are performance within nominal thresholds, the user interface may be configured to provide an indication that related objects are performing as expected and/or nominally.

An example method comprising receiving network data related to objects of an enterprise system, the network data being received from a plurality of enterprise monitoring systems, each object being a digital device, a virtual machine, virtual device, or application, analyzing the received network data to identify performance metric data related to any number of objects of the enterprise system, the performance metric data indicating performance of the any number of objects in real time, receiving, from a user interface, a selection of an object identifier of an enterprise system, the object identifier identifying a first object of the objects of the enterprise network, identifying an object subset that includes the object identifier, the object subset including some objects of the enterprise network that are related to each other by communication or performance of similar functions, and if performance metrics from the network data for any of the objects in the object subset are performing outside of nominal thresholds, providing at least some performance metric data to the user interface regarding the those objects in the object subset.

In some embodiments, the performance metric data includes performance information received from the enterprise monitoring system. In another example, the performance metric includes analysis of performance metric data received from the enterprise monitoring system. In various embodiments, when performance metrics from the network data for any of the objects in the object subset are performing outside of nominal thresholds comprises changes in metric parameters over time are outside of a nominal threshold. In on example, the performance metrics from the network data for any of the objects in the object subset includes an analysis of performance metrics, when a result of the analysis is performing outside of nominal threshold, provide at the result of the analysis to the user interface regarding the first object. In some embodiments, the performance metrics performing outside of nominal thresholds may be two or more performance metrics for the same object of the enterprise network. In various embodiments, at least one of the nominal thresholds changes dynamically or may be received from the user interface. In some embodiments, if the performance metrics from the network data for all objects in the object subset are performance within nominal thresholds, the user interface may be configured to provide an indication that related objects are performing as expected and/or nominally.

An example computer program product comprising a non-transitory computer readable storage medium having a program code embodied therewith, the program code executable by a computing system to cause the computing system to perform receiving network data related to objects of an enterprise system, the network data being received from a plurality of enterprise monitoring systems, each object being a digital device, a virtual machine, virtual device, or application, analyzing the received network data to identify performance metric data related to any number of objects of the enterprise system, the performance metric data indicating performance of the any number of objects in real time, receiving, from a user interface, a selection of an object identifier of an enterprise system, the object identifier identifying a first object of the objects of the enterprise network, identifying an object subset that includes the object identifier, the object subset including some objects of the enterprise network that are related to each other by communication or performance of similar functions, and if performance metrics from the network data for any of the objects in the object subset are performing outside of nominal thresholds, providing at least some performance metric data to the user interface regarding the those objects in the object subset.

### BRIEF DESCRIPTION OF THE DRAWINGS

FIG. 1 depicts an example environment with an enterprise system capable of providing an in-context dashboard according to some embodiments.

FIG. 2 depicts a block diagram of an enterprise system capable of providing an in-context dashboard according to some embodiments.

FIG. 3 depicts a block diagram of an example of an in-context dashboard system according to some embodiments.

FIG. 4 depicts a flowchart of a method of identifying object subsets according to some embodiments.

FIG. 5 depicts a flowchart of a method of providing an in-context dashboard according to some embodiments.

FIG. 6 depicts a flowchart of another method of providing an in-context dashboard according to some embodiments.

FIG. 7 is a graph which depicts an example of the different range and thresholds according to some embodiments.

FIG. 8 depicts an example of a noisy neighbor scenario according to some embodiments.

FIG. 9 depicts an example of an in-context dashboard system output interface according to some embodiments.

FIG. 10 depicts an example of an in-context dashboard system output interface according to some embodiments.

FIG. 11 depicts an example of an in-context dashboard system output interface according to some embodiments.

FIG. 12 depicts another example of an in-context dashboard system output interface according to some embodiments.

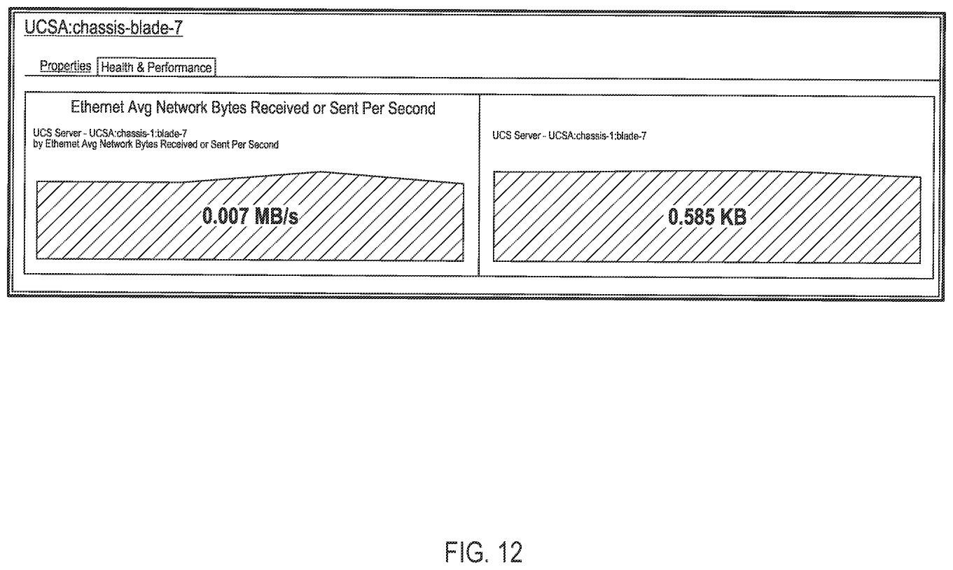

FIG. 13 depicts a block diagram illustrating entities of an example machine according to some embodiments.

### DETAILED DESCRIPTION

Various embodiments enable customers to deliver on the complex requirements of an enterprise network. Systems discussed herein may provide insights into the performance and availability of an end-to-end system—across physical, virtual, and/or cloud environments. The system may intelligently capture, correlate, and/or analyze both breadth and depth of data, transforming data regarding assets/applications of an enterprise network into answers and actionable insights.

An in-context dashboard system may be used to provide a report of the top N metrics of the enterprise network to a graphic display of a user system associated with the enterprise network. The in-context dashboard system may choose among thousands of pieces of network information and choose N metrics to display to the user. Metrics may be received from any number of performance monitoring systems. Metrics may be the results of analysis of metrics received from performance monitoring systems. Network information may include information of entities of the enterprise network and metrics associated with one or more entities of the enterprise network. The context which the dashboard system uses to determine or identify the top N metrics may be based on a current scope of the user. A current scope may be determined based on many factors, including the user's position in the enterprise, a history of metrics or network objects the user has interacted with in the past, a current network object the user is interacting with, and/or network objects related to a network object the user is currently interacting with.

Other factors, such as machine-learning-driven insights may be taken into account when determining the current scope of the user. For example, a machine learning algorithm may determine that a particular metric is provided to the user due to seasonal anomalies or an event of interest that only occurs during certain times of the day, week, month, or year. In some embodiments, the in-context dashboard system may provide the metric in different forms based on the context of the user using the in-context dashboard system.

An in-context dashboard system may be used to give IT administrators an awareness of network objects of the enterprise network. Network objects include physical and virtual objects of the network which communicate with each other by receiving, sending, and transmitting data. For example, the in-context dashboard system may obtain real-time views of the performance, health, and capacity of a software-only server-based storage array network (SAN) by correlating data from different sources to provide a comprehensive real-time view of network objects of the enterprise network from different aspects. The context may include an entity of the enterprise network, the scope of the enterprise network entities related to a particular entity of the enterprise network, and other factors such as machine-learning driven insights. One or more of the contexts may be selected by a user of the in-context dashboard system. Entities of the enterprise network may include but are not limited to virtual machines (VMs), hosts, applications, servers, routers, switches, storage devices, and applications.

The in-context dashboard system may provide the top N metrics of the enterprise network to the graphic display in the form of a graph, a chart, or a table. In some embodiments, the top N metrics provided to the user may change as the user navigates the user interface provided to the graphics display.

For example, the in-context dashboard system may receive a request to view metrics regarding a particular hypervisor of the enterprise network. In response, the in-context dashboard system may provide the top 10 metrics associated with the particular hypervisor. In this example, the user may notice that the CPU usage of the particular hypervisoris outside a nominal threshold. As a result, the user may send a request to view metrics associated with a particular virtual machine (VM) on the hypervisor. In response, the in-context dashboard system may provide the top 10 metrics associated with the particular virtual machine. Some or all of the top 10 metrics associated with the particular hypervisor may be different from the top 10 metrics associated with the particular virtual machine. In some embodiments, the nominal threshold associated with each metric is pre-set by the user. In various embodiments, the nominal threshold changes dynamically based on properties such as the time of day, week, month, or year. The nominal threshold may depend on properties of the entity associated with the metric, such as a tier of service of the entity, a metric associated with an entity with a higher tier of service may have a lower nominal threshold than the same metric associated with an entity with a lower tier of service. In some embodiments, the number of metrics provided may be less or more than ten.

The in-context dashboard system may compare each of the metrics received from performance monitoring systems or the results of analysis of metrics received from performance monitoring systems with respective nominal thresholds. In some embodiments, the in-context dashboard system may flag objects as possible candidates to show to a user (e.g., based in part on the user's current activities) if objects are not acting normally (e.g., compared to past behavior) or are not within nominal thresholds (but below alarm conditions). If some or all of the objects are acting normally or are within nominal thresholds, the in-context dashboard system may provide notification to the user to indicate that objects related to the selections of the user are performing as expected and/or nominally (e.g., within nominal thresholds).

If an alarm trigger condition is satisfied based on the comparison, an alarm event may be triggered. The in-context dashboard system may output an alarm notification based on the alarm event. The alarm notification may identify properties or attributes of the alarm, such as the severity of the alarm, the name of the alarm, and the nominal threshold that was exceeded. In some embodiments, the alarm notification may include a templatized remediation. The templatized remediation may include a change that may be made to a network object that may resolve the alarm that has been proven to work in the past.

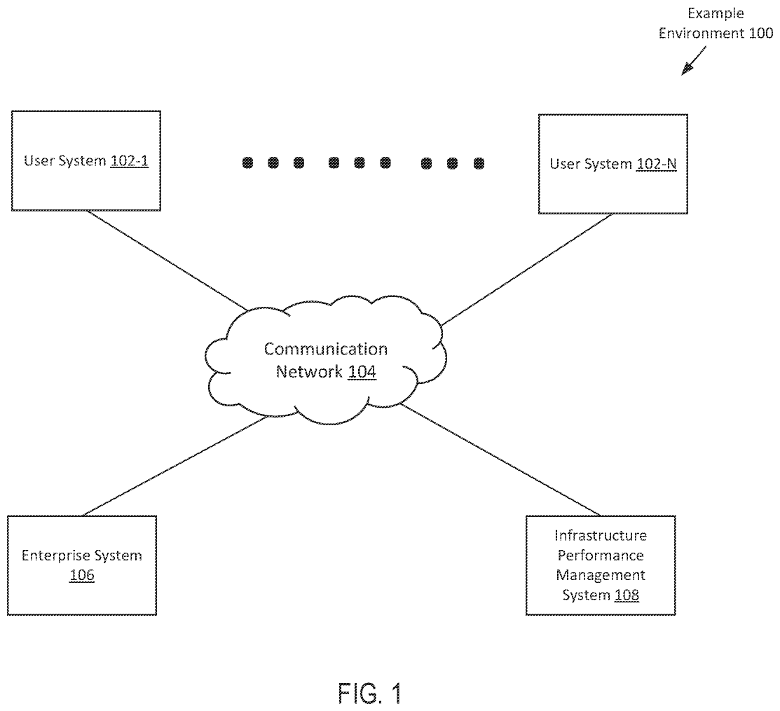

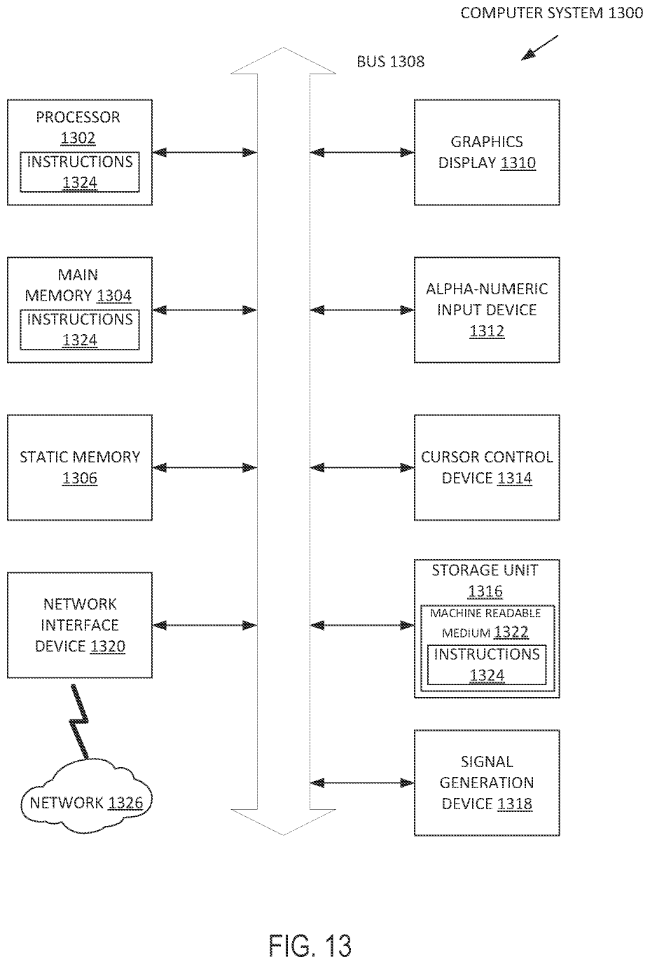

FIG. 1 depicts an example environment 100 with an enterprise system capable of collecting network data from different sources, analyzing the data, and providing an in-context dashboard according to some embodiments. In this example, the environment 100 includes user systems 102-1 to 102-N (individually, user system 102 collectively), communication network 104, an enterprise system 106, and an infrastructure performance management system 108. The user systems 102-1 to 102-N, the enterprise system 106, and infrastructure performance management system 108 may each be or include any number of digital devices. A digital device is any device with a processor and memory. Digital devices are further discussed herein (e.g., see FIG. 13).

In some embodiments, user system 102-1 may be configured to facilitate communication between users and other associated systems. The user system 102-1 may be a part of the enterprise system 106 or may have access to performance metrics of the enterprise system 106. In some embodiments, the user system 102-1 may be or include one or more mobile devices (e.g., smartphones, cell phones, smartwatches, tablet computers, or the like), desktop computers, laptop computers, and/or the like. In various embodiments, the user system 102 includes a graphics display. A user interface provided by the infrastructure performance management system 108 may be outputted to the graphics display. The user may interact with the graphics display to provide input of a selection to the infrastructure performance management system 108.

In some embodiments, communication network 104 represents one or more computer networks (e.g., LANs, WANs, and/or the like). The communication network 104 may provide communication between any of user system 102, the enterprise system 106, and the infrastructure performance management system 108. In some implementations, the communication network 104 comprises computer devices, routers, cables, uses, and/or other network topologies. In some embodiments, the communication network 104 may be wired and/or wireless. In various embodiments, the communication network 104 may comprise the Internet, one or more networks that may be public, private, IP-based, non-IP based, and so forth.

In this example, users may interact with user system 102-1-102-N using, for example, a web browser or mobile application to communicate with other users, access web graphical user interfaces of the infrastructure performance management system 108 and/or interact with applications on their own devices to receive performance metrics from the infrastructure performance management system 108.

In some embodiments, the enterprise system 106 may represent components that make up an enterprise, including an enterprise network. Components of the enterprise system may be physical, such as switch ports, virtual, such as virtual machines, or cloud computing components.

The user of user system 102 may create an account on the infrastructure performance management system 108 before accessing the information on the infrastructure performance management system 108.

The infrastructure performance management system 108 may monitor the performance, health, and capacity of entities of the enterprise network. The infrastructure performance management system 108 may include any number of performance monitoring systems, such as application discovery systems or a flow source discovery systems that may provide network information to an in-context dashboard system.

The in-context dashboard system may utilize this information to provide metrics based on a current context. The current context may include an entity of the enterprise network, the scope of the enterprise network entities related to a particular entity of the enterprise network, and other factors such as machine-learning driven insights.

In one example, the infrastructure performance management system 108 may observe a user's interaction with in-context dashboard. Based on the user's interactions with the in-context dashboard, the infrastructure performance management system 108 may select a limited number of metrics of interest related to the selections by the user. The selected limited number of metrics may be based on relationship with the selections of the user as well as performance at or near the time of the user's selections. In one example, the infrastructure performance management system 108 may assess performance of any number of entities by comparing metrics to thresholds. The infrastructure performance management system 108 may automatically display any number of the metrics to the user based on the user's selection and the performance of the metrics. For example, the infrastructure performance management system 108 may determine that the user is investigating SAN performance and subsequently display metrics of systems in communication with the particular SAN that the user has identified, particularly if those metrics are behaving abnormally (e.g., are abnormally communicating with the SAN but less than an ordinary alert).

The infrastructure performance management system 108 may be used to provide a report of any number of metrics. In some embodiments, the infrastructure performance management system 108 provides the top 10 (or any number of) metrics of the enterprise network to a user interface of the user system 102. The top metrics may be chosen based on the role of the user in the enterprise network. In some embodiments, top 10 metrics are chosen based on an object or entity of the enterprise network.

In various embodiments, the top metrics are chosen based on alarm events or events of interest. Alarm events may be determined based on run-time behaviors observed by the infrastructure performance management system 108. In some embodiments, an alarm event is triggered when a metric is outside a nominal threshold (e.g., comparing the metric to a particular threshold and/or past behaviors).

In various embodiments, an alarm event is triggered when a result of an analysis on a metric is outside a nominal threshold. An example of an alarm event may be a metric that has changed significantly in a short period of time. In some embodiments, the number of metrics that are provided to the user interface may be determined by the user of the user system 102. An event of interest is triggered when a particular metric is outside a nominal range but not quite in a range that triggers an alarm. An event of interest may be a pre-alarm, alerting the user of a potential problem with the enterprise network. In some embodiments, a range between the nominal threshold and an alarm threshold may be a gray area outside the nominal, everything-is-okay range. In some embodiments, an event of interest may be triggered when one or more metrics are within the nominal (e.g., everything-is-okay) range.

The nominal threshold may be determined by the user of the infrastructure performance management system 108. In some embodiments, the nominal threshold changes dynamically based on properties such as the time of day, week, month, or year. In various embodiments, the nominal threshold may depend on the properties of the entity associated with the metric.

Although discussion included herein may discuss web pages or application interfaces without reference to the other, it will be appreciated that systems and methods described herein may apply to applications, application interfaces, web pages, and websites.

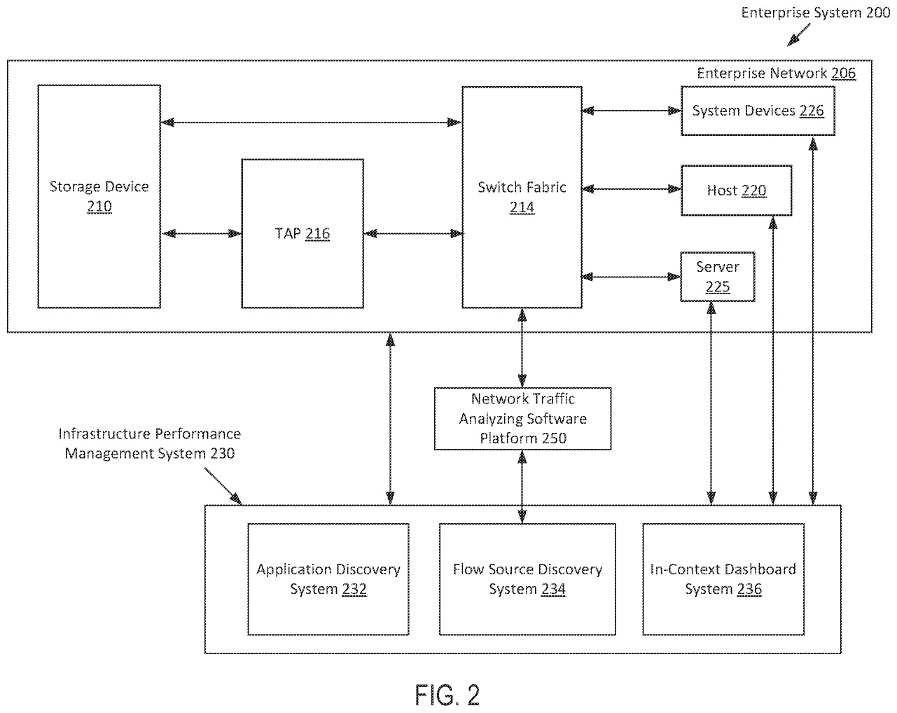

FIG. 2 depicts a block diagram of an enterprise system 200 capable of providing an in-context dashboard. The enterprise system may include an enterprise network 206, an infrastructure performance management system 230, and a network traffic analyzing software platform 250. The enterprise network 206 includes a storage device 210, a host 220, a server 225, system devices 226, a switch fabric 214, and a traffic access point (TAP) 216. The infrastructure performance management system 230 includes an application discovery system 232, a flow source discovery system 234, and an in-context dashboard system 236.

The storage devices 210 of the enterprise system 200 include one or more storage system(s) that stores data. In some embodiments, the storage devices 210 include a disk array. In some embodiments, a storage device includes a SAN. In various embodiments, the storage device is cloud storage. In one example, the network object may be a software-only server-based SAN. The object data associated with the software-only server-based SAN may be an IP address of the storage device. Metric data associated with the software-only server-based SAN may include average read latency, average write latency, primary read from device IOPS, and primary write IOPS, user data read IOPS, user data write IOPS, number of ScaleIO devices, total read throughput, and total write throughput.

The host 220 of the enterprise system 200 may include a physical computer or server which sends or receive data, services, or applications. Hosts may also be connected to other computers or servers via a network. In some examples, the host 220 may be an instance of an operating system. For example, the hosts 220 may include instances of UNIX, Red Hat, Linux and others. In some embodiments, the hosts 220 may include a physical computer managed by Microsoft Windows. Hosts 220 may include one or more virtual machines.

Server 225 may include computer software or hardware used to store network connections and store data. In some embodiments, the server 225 may be a physical computer or virtual machine which provides data to other computers.

System devices 226 may include entities of the enterprise network 206, such as third-party software platforms subscribed to by the enterprise network 206. In various embodiments, the third-party software platform includes IT management software such as ServiceNow or an application performance integration platform such as AppDynamics. ServiceNow or AppDynamics may provide an application to virtual machine mapping to the application discovery system. The application to virtual machine mapping may aid the application discovery system in providing a real-time application to host mapping.

The switch fabric 214 may use packet switching to receive, process, and forward data from a source device to a destination device. The switch fabric 214 may include any number of switches, such as routers, bridges, or the like. The switch fabric 214 may provide communication between any two entities of the enterprise system 200 such as the storage device 210, the host 220, the server 225, system devices 226, the switch fabric 214, and the TAP 216, the infrastructure performance management system 208, and the network traffic analyzing software platform 250. The switch fabric 214 may use packet switching to receive, process, and forward data from a source device to a destination device. The switch fabric 214 may refer to switches (e.g., flow sources) that are used to direct and assist in the communication of information of the enterprise network 206.

The TAP 216 may include an optical splitter that provides a copy of data passing through a fiber optic channel without affecting the integrity of the data. The fiber optic channel may connect the storage devices 210 to the server 225. The copy of data may be used for real-time performance monitoring of data traffic traveling through the fiber optic channel. The TAP 216 may provide connectivity to links between storage ports of the storage device 210 and switches of switch fabric 214. In various embodiments, the TAP 216 may provide connectivity on both sides of fabric-based storage virtualizers such as cloud-based storage. In one example, the TAP 140 is an optical splitter that provides a copy of data passing through a fiber optic channel of the enterprise network 105 without affecting the integrity of the data. In this example, the fiber optic channel may connect storage devices (of a SAN) with servers of the enterprise network. The copy of the data may be used for real-time performance monitoring of traffic traveling through the fiber optic channel and/or to assist with application discovery.

The network traffic analyzing software platform 250 may discover flow sources on the enterprise network 206. The network traffic analyzing software platform 250 may be any third-party platform that is integrated into routers or switches by their respective manufacturers to aid users in monitoring the performance of traffic data entering and exiting that specific switching hardware. An example of a network traffic analyzing software platform 250 is Netflow. Although the network traffic analyzing software platform 250 of a particular provider may perform some flow source detection, the network traffic analyzing software platform 250 may provide only limited information about the flow sources (e.g., limited metrics) and may not include other switches of other manufacturers (i.e., that is not a part of that particular providers network traffic analyzing software platform 250). In some embodiments, the software platform 250 is optional.

In some embodiments, the network traffic data may be in the form of flow packets. Each flow packet includes any number of flow records, a template record, and a packet header. Any number of flow records may provide information associated with each flow. In various embodiments, the data packet includes one or more template identifiers. Each of the flow records may be generated by one of any number of flow sources in a data path.

Object data, as the name implies, represents an object of the enterprise network and may include an internet protocol (IP) address and attributes of the network object. In some embodiments, network objects of the enterprise network 206 include entities of the enterprise network 206, such as the host 220, an entity of the switch fabric, the storage device 210, and the server 225. In various embodiments, the network object may represent an application instance of the enterprise network 206. Metric data includes metrics of a network object. In some embodiments, metric data includes measurable time-varying attributes of the network object.

For example, the object data associated with an entity of the switch fabric 214, such as a router may include the IP address of the router, the manufacturer of the router, such as Cisco, and the version of the traffic monitoring software integrated into the router. Metrics data associated with the router may include read speed total byte count, incoming byte count, outgoing byte count, incoming bit rate, outgoing bit rate, and total packet rate.

The tier of service may be used to prioritize one application or group of applications over another. The tier of service may also be used to group similar service levels, which may correspond to critical levels of applications. In one example, the enterprise network may comprise four tiers, with the most important and business-critical tier named “tier 0”, followed by, in order of decreasing importance, “tier 1,” “tier 2”, and “tier 3.” The tier of service of an application propagates to the entities associated with the application.

In one example, the infrastructure performance management system 230 includes the application discovery system 232, the flow source discovery system 234, and the in-context dashboard system 236. The application discovery system 232 identifies entities of an enterprise network, integrates data from software platforms already subscribed by the enterprise network 206, and retrieves data from probes to monitor various entities of the enterprise network. In some embodiments, the probes are hardware probes, software probes, or a combination of the two. In various embodiments, the probes are plug-ins that come built-in with various network monitoring platforms. In some embodiments, a probe may include an optical splitter that provides a copy of data passing through a fiber optic channel of the enterprise network 206 without affecting the integrity of the data. The fiber optic channel connects storage devices with servers of the enterprise network. The copy may be used for real-time performance monitoring of the traffic traveling through the fiber optic channel. The information obtained from the probes may suggest from heuristic implications that applications could exist on the enterprise network 206.

The application discovery system 232 may receive from the flow source discovery system 234 possible roles of network endpoints. These possible network endpoint roles may be used by the application discovery system 232 to discover applications through heuristic analysis. For example, data received from a known flow source (e.g., discovered by the flow source discovery system 234) may be assessed to determine what applications provided and/or received information from the data. Data received from a known flow source may be, in one example, intercepted or copied from a TAP that interfaces with communication paths of the enterprise network 206. Based on that information, as well as the type of communication, the frequency of communication, and/or the like, the application discovery system 232 or the flow source discovery system 234 may label a network endpoint with one or more roles performed within the enterprise network 206. The output of the application discovery system 232 may be a list of applications on the enterprise network and entities of the enterprise system associated with each of the applications.

In some embodiments, the process of application discovery includes integrating information from software platforms that manage or monitor the performance of applications on the enterprise network 206. For example, application discovery system 232 may take information regarding applications discovered by ServiceNow along with information from SSH or WMI to obtain a more accurate topology of entities involved in applications of the enterprise network 206. The enterprise may choose to subscribe to software platforms such as ServiceNow and AppDynamics to monitor entities of the enterprise network 206 known to be associated with business-critical applications.

In some embodiments, the in-context dashboard system 236 may receive the list of applications from the application discovery system 232.

The process of application discovery may include the application discovery system 232 implementing secure shell (SSH) or windows management instrumentation (WMI) to communicate with entities of the enterprise network 206. The application discovery system may take information received from SSH and WMI protocols and apply heuristics to suggest from heuristic implications what applications could exist. For example, the application discovery system 232 may determine that entities of the enterprise network 206, which communicate with each other at regular intervals throughout the day and were introduced to the enterprise network 206 at around the same time, may be a part of the same application.

In some embodiments, the in-context dashboard system 236 receives from the flow source discovery system 234 possible roles of network endpoints. These possible network endpoints may be used by the in-context dashboard system 236 to identify network objects and metrics associated with the identified network objects. Network objects may include physical and virtual objects of the enterprise network which communicate with each other by receiving, sending, and transmitting data. The in-context dashboard system 236 may utilize the information received from the flow source discovery system 234 to provide a current context.

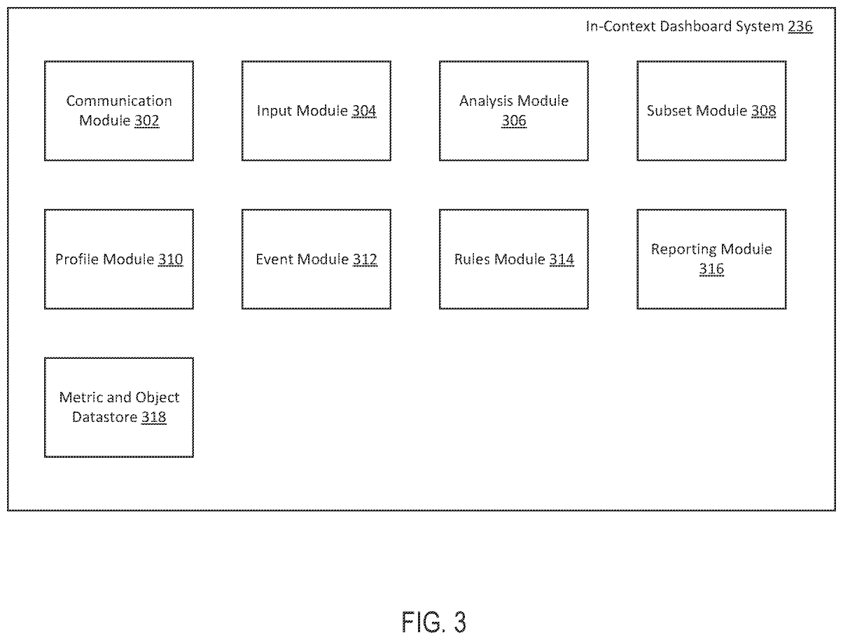

FIG. 3 depicts a block diagram of an in-context dashboard system 236 according to some embodiments. The in-context dashboard system 236 includes a communication module 302, an input module 304, an analysis module 306, a subset module 308, a profile module 310, an event module 312, a rules module 314, a reporting module 316, and a metric and object datastore 318.

The communication module 302 may send and receive requests or data between any of the in-context dashboard system 236, application discovery system 232, flow source discovery system 234, and any of the entities of the enterprise network 206. In some embodiments, the communication module 302 may send or receive a request from the user system 102.

The input module 304 may receive data from any of the application discovery systems 232, flow source discovery system 234, and the users of the enterprise network 206. The information received from the application discovery system 232 may include a list of applications discovered by the application discovery system 232. The received information may also include a list of some or all the entities of the enterprise network 206. In some embodiments, the input module 304 creates or identifies objects associated with the enterprise network 206. Objects include applications, entities, virtual machines, hardware systems, and the like. Object identifiers may be application identifiers, entity identifiers, virtual machine identifiers, hardware systems identifiers, and the like.

Network objects of the enterprise network may include entities of the enterprise network, such as virtual machines (VMs), hosts, applications, servers, routers, switches, storage devices, and applications. Network objects may be categorized by object identifiers. In some embodiments, an object identifier may be an internet protocol (IP) address. In one example, the network object is an application, and the object identifier is a name of the application given by the application discovery system 232 or a user of the enterprise network 206. In addition to identifying network objects and metrics associated with identified network objects, the analysis module 306 may identify properties of the identified network objects, such as a tier of service of the network object. Once a metric and/or a network object is identified, the analysis module 306 may send a request to the metric and object datastore 318 to store the identified metric and/or network object.

Object data may include application data. Application data may include attributes of the object such as a tier of service of an application, a name of the application, and entities of the enterprise network which make up the application. In some embodiments, the application data includes application metrics such as application read response time, and application write response time.

The information received from the flow source discovery system 234 may include network traffic data. In some embodiments, the network traffic data includes at least one of a source entity of the enterprise network (e.g., identifier of a sending device), a destination entity of the enterprise network (e.g., identifier of a receiving device), and metrics of the network traffic. The metrics of the network traffic data include at least one of a type of flow source, read speed total byte count, incoming byte count, outgoing byte count, incoming bit rate, outgoing bit rate, and total packet rate. In some embodiments, the information received from the source discovery system 324 may include performance metric data. Performance metric data may include data received from different performance systems (e.g., from probes, ServiceNow, and the like) as well as processed data received from such systems (e.g., averaging, evaluation against functions and thresholds, and the like).

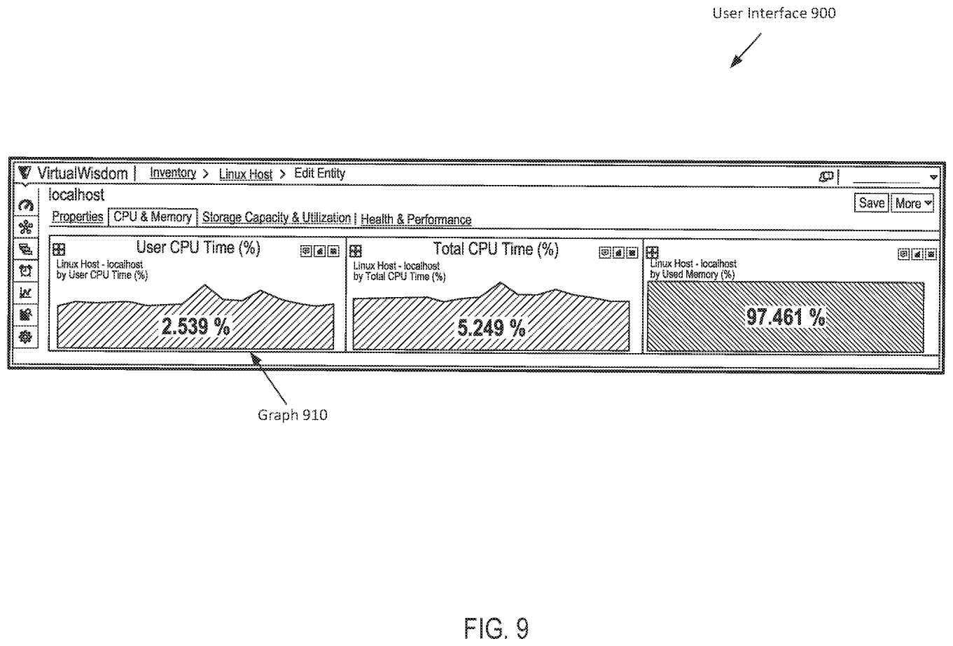

In some embodiments, the input module 304 may receive information from a user of the in-context dashboard system 236 when the user interacts with a graphical user interface such as a user interface 900 of FIG. 9. For example, the user may interact with the graphical user interface to select a particular object from a topology of the enterprise network. The in-context dashboard system 236 may receive this information to determine events of interest associated with the particular object or determine an object subset that includes objects of the enterprise network related to the particular object. In some embodiments, the input module 304 receives from the user when the user interacts with a report generated by the reporting module 316 and provided to the user interface.

In various embodiments, the input module 304 may receive a user identifier (e.g., a login identifier) and password from the user of the in-context dashboard system 236. User identification information may include, for example, an email address, password, phone number, company position, and the like. User identification information may be used by the in-context dashboard system 236 to identify events of interest and provide a report of top metrics for the user. In some embodiments, the input module 304 may receive a selection of a particular network object or metric when the user interacts with the user interface provided by the reporting module 316.

For example, the analysis module 306 may receive a list of applications from the application discovery system 232. The analysis module 306 may analyze the list of applications and identify one or more entities and/or objects of the enterprise network 108 associated with the application. The analysis module 306 may optionally propagate properties of the application, such as tier of service, to entities associated with the application.

The analysis module 306 may analyze the data received by the in-context dashboard system 236 to identify network objects of the enterprise network and metrics associated with objects of the enterprise network.

The analysis module 306 may utilize the information received from the different sources to identify any number of metrics that may be of interest to the user. The analysis module 306 may utilize information of events of interest from the event module 312 to determine recent events and interest along with user information from the profile module 310 to identify metrics to provide to the user on a graphical user interface. In some embodiments, the analysis module 306 provides metrics to the user based on a selection of a particular network object or entity of the enterprise network. Once the metrics have been identified, the information and/or a graphical representation of each of the metrics may be provided to the reporting module 316. As the user navigates and interacts with metrics on the graphical user interface, the analysis module 306 may optionally dynamically change related metrics (e.g., those metrics not specifically requested by the user) provided to the graphical user interface. In one example, if the user is presented with multiple metrics from different entities of the enterprise network, and the user interacts with a particular metric associated with a particular entity, the graphical user interface may provide metrics associated with the particular entity or the same particular metric of entities in a same object subset of the particular entity.

Each of the metrics may be provided to the user (e.g., displayed) in the form of a graph, a chart, or a table. An example of the graphical user interface may be seen in FIG. 9. In some embodiments, the form of the output presented to the user may depend on a type of user. In some embodiments, the number of metrics provided to the graphical user interface may be more or less than ten metrics.

In various embodiments, the subset module 308 identifies an object subset for each of the previously identified network objects of the enterprise network. A subset of objects may each impact or relate to each other's performance. A particular application may include a set of objects that enable that particular application to perform its function. As such, that set of objects may be within the particular application's object subset. Further, systems that impact performance of that particular application (e.g., a SAN that operates directly with the particular application, ports that are part of the communication with the particular application, VMs that share similar infrastructure with the particular application, and the like) may be a part of that particular application's object subset.

Each object may be a part of any number of different object subsets. In various embodiments, object subsets may be dynamically reassigned depending on new object installations (e.g., new software, new hardware, changes in communication paths), removal of objects (e.g., replacement of hardware, updating software, failure of a network router), and/or performance changes (e.g., caused by optimization processes for communication and performance such as bandwidth re-allocation).

Network objects in the object subset for a particular network object may be network objects that are related to the particular objects by performance of similar functions. For example, if a particular network object is a VDI, network objects in the VDI's object subset may include a SAN, hypervisors, and VMs, which make up the particular VDI application. In another example, if the particular network object is a particular VM, network objects in the particular VM's object subset may include a host of the particular VM, other VMs which share the same host, the particular VM's hypervisor, and applications running on the particular VM. Each network object of the enterprise may belong to one or more object subsets.

In some embodiments, the subset module 308 may send a request to the metric and object datastore 318 to create or update a metric and object data entry for a particular network object when the subset module 308 identifies an object subset for the particular network object.

In some embodiments, network objects in the object subset for a particular network object are network objects that are related to the particular objects by communication. For example, if the particular network object is a particular router, then network objects in the particular router's object subset may include other entities of the enterprise network in direct communication with the particular router. Objects in an object subset may change periodically, so the subset module 308 may determine an object subset for one or more of the identified network objects periodically. In some embodiments, the subset module 308 utilizes flow records from the flow source discovery system 234 to identify network objects in communication with a particular network object to identify that particular network object's subset. In various embodiments, the subset module 308 may update a network object's object subset based on information received from the analysis module 306 or one or the application discovery system 232.

In response to a user inputting a user identifier, the profile module 310 may retrieve a user profile associated with the user. In some embodiments, the user profile includes information such as the company position of the user in the enterprise network, a history of metrics the user has interacted with in the past. The user profile may be used by the in-context dashboard system 236 to identify some of the metrics or network objects that may be of interest to the user. For example, a Chief Technology Officer (CTO) of an enterprise may log into the in-context dashboard system 236 to view and monitor the overall health of a data center. The in-context dashboard system 236 may provide a report that provides high-level statistics of the data center, such as average CPU usage, amount of storage available, amount of network traffic aggregated by applications.

The profile module 310 may also monitor and keep track of the amount of time a user spent interacting with one or more metrics provided on the graphical user interface to determine metrics or network objects that may be of interest to the user. For example, as the amount of time that the user utilizes to investigate one or more objects increases, the in-context dashboard system 236 may assess and provide more focused information regarding those objects or related objects.

The event module 312 may determine or identify events of interest when the criterion or criteria for an event of interest is satisfied. Events of interest may be identified based on run-time behaviors captured as metrics. In some embodiments, events of interest include alarm events. An example of an event of interest may be a particular metric exceeding an alarm threshold, which triggers an alarm. In some embodiments, an event of interest is triggered when a particular metric is greater than an upper nominal threshold. In various embodiments, an event of interest is triggered when a particular metric is outside a nominal range. In some embodiments, an event of interest is triggered when some or all of metrics associated with some or all objects in an object subset are within a nominal range.

In some embodiments, an event of interest is triggered when some or all metrics associated with other objects in a particular object's subset are within a nominal range even though metrics associated with the particular object are outside the nominal range. For example, throughput for a volume may be low (and outside the nominal range for that particular volume) due to slow down in either the network or storage. The event of interest may be triggered to indicate that the network is in the nominal range, and that the low throughput may be caused by storage.

In some embodiments, an event of interest is triggered when a particular result of an analysis of metrics exceeds an upper nominal threshold or is outside a nominal range. In some embodiments, an event of interest is triggered when a slope or a rate of change of a particular metric changes significantly in a short period of time. In one example, an event of interest is triggered when a combination of two or more metrics meets some criteria.

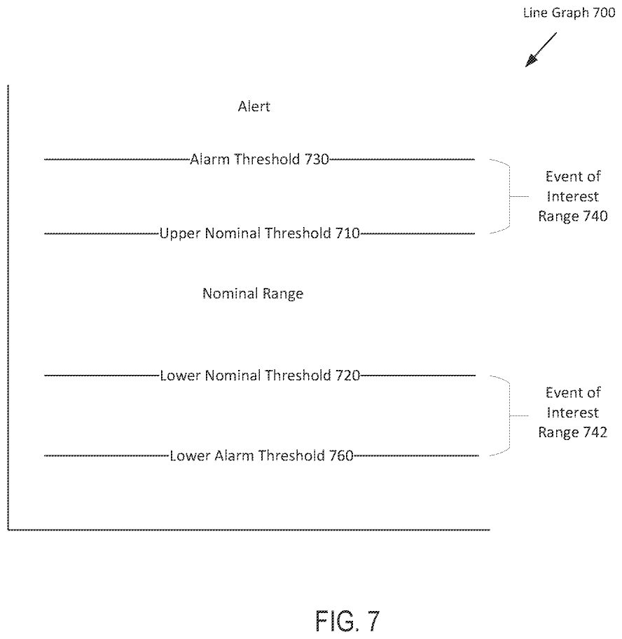

Examples of these thresholds and ranges may be seen in FIG. 7. In some embodiments, the alarm threshold or the nominal range may be provided by the user. For example, the user may determine that CPU usage under 70% is still within a nominal range, while an event of interest may be triggered when CPU usage is more than 70%. As such, the user may provide threshold ranges for comparison by the system.

In various embodiments, the alarm threshold or the nominal range changes dynamically based on properties such as the time of day, week, month, or year. For example, weekends may have less utilization than during the day on a weekday. In another example, backups and other network intensive activities may be scheduled for certain times (e.g., 3 AM) and, as such, different thresholds may be utilized for determining if one or more objects are performing nominally (e.g., nominal at the time of analysis or comparison against thresholds).

In some embodiments, the alarm threshold or the nominal range may be inferred based on analytics that detect seasonal anomalies. For example, CPU usage for a particular entity may have a historical average CPU usage of 25% during a particular period of time each day, and the system may set a threshold at that CPU usage. If, on a day in the future, the CPU usage for that particular entity is averaging 5%, the system may identify that the particular entity is not behaving nominally. In various embodiments, the alarm threshold or the nominal range depends on properties of the network object associated with the metric, such as a tier of service of the network object.

In some embodiments, the event module 312 may identify that a metric of a particular entity triggered an alarm. The event module 312 may determine if the same metric of entities related to the particular entity triggers an alarm as well. For example, if the read speed of port X triggers an alarm, the event module 312 may determine if the read speed of the host triggers an alarm or is outside a nominal range. In some embodiments, an event of interest may be triggered for a particular network object when an alarm or event is triggered for a nearby or neighboring network object. For example, a Tier 3 host may have a “CPU Utilization” alarm while Tier 2 hosts have “Write Response Alarms” because Tier 3 applications are CPU intensive while Tier 2 applications are write-intensive. A particular host may be classified as both Tier 2 and Tier 3 simultaneously, that host would have both those alarms active. A critical failure in a host could be caused by either the CPU being overutilized or the write response being too high, which may lead to a system-wide failure to the device. A Tier 2 application that is write-intensive and not CPU intensive can be affected by over-utilized CPU if it shares the host with a Tier 3 application.

In some embodiments, an application may be out of compliance (e.g., not operating as expected or not within normal expectations) because one of its resources is out of compliance caused by a different application (e.g., a “noisy neighbor problem”). In one example of the “noisy neighbor problem,” an alarm or event of interest may be triggered in one network object when another network object (which is in communication or performs a similar function as the one network object) triggers an alarm or is an event of interest.

The rules module 314 determines or sets an alarm threshold or boundaries of a nominal range for each metric associated with each of the network objects of the enterprise network. In some embodiments, the rules which determine the various thresholds and boundaries are based on properties of the network object associated with the entity, such as a tier of service of the entity. For example, a nominal range of incoming bit rate of a tier 1 router may be smaller than a nominal range of incoming bit rate of a tier 3 router. In some embodiments, the rules which determine the various thresholds and boundaries are based on other factors such as the time of day, week, month, or year. In one example, the various thresholds and boundaries may be determined by the user. The user may interact with a user interface and input values for one or more of the thresholds and nominal boundaries of metrics associated with various network objects. In some embodiments, the rules module 314 includes an optional lower alarm threshold.

The reporting module 316 may provide, to a user interface, a graphical representation of the top ten metrics as determined by the analysis module 306. The graphical representation may be in the form of a graph, a chart, or a table. In some embodiments, the reporting module 316 may group the graphical representation of multiple metrics and sort them by different tabs. When the user interacts with the graphical representation of a particular metric, the reporting module 316 may provide the raw data associated with the graphical representation. For example, graph 910 of FIG. 9 depicts a line graph of the user CPU time. The graph 910 may include an indication that the average user CPU time percentage during the time period depicted by the graph 910 is 2.539%. The user may interact with the graph 910 anywhere along the line of the line graph, and the reporting module 316 may present the user CPU time percentage at that particular point in time.

In response to an alarm event or an event of interest, the reporting module 316 may provide notification to users of the in-context dashboard system 236. The users of the in-context dashboard system 236 may customize the properties of notification of an alarm event or event of interest. Properties include a type of notification, which includes a pop-up window on the user interface of the user system, an email, a text message, or a telephone call, frequency of notification, and message of the notification. Properties of the notification may depend on the properties of the metric and/or properties of the network object associated with the metric. In some embodiments, the reporting module 316 may provide a notification to the user in response to a real-time alarm event or a real-time event of interest. For example, the triggering of a tier 3 alarm may result in a pop-up window in the user interface, while the triggering of a tier 0 alarm may result in the pop-up window in the user interface as well as an email sent to a designated user of the enterprise network.

The metric and object datastore 318 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solr, and the like). The metric and object datastore 318 may receive a request from the analysis module 306 to create or update a metric and object data entry. Each data entry may include a metric associated with a network object of the enterprise network. Each network object may be associated with multiple metrics. In some embodiments, data entries are updated in real-time or in predetermined intervals. In various embodiments, data entries include information regarding the object subset. In some embodiments, data entries include properties of the network object associated with the data entry, such as tier of service, temperature tolerances, network type, throughput, maximum bandwidth, and the like.

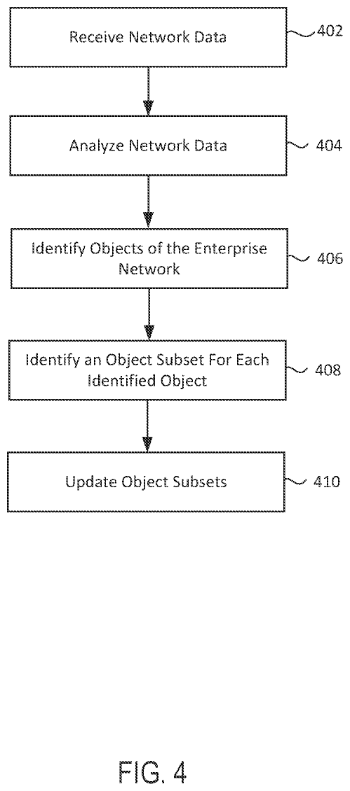

FIG. 4 depicts a flowchart of method 400 of identifying object subsets according to some embodiments. In step 402, the input module 304 receives data from any one or a combination of data sources, including the application discovery system 232, the flow source discovery system 234, and users of the enterprise network 206. For example, the input module 304 may receive an inventory of network applications identified by the application discovery system 232. The inventory may include the identified application and some or all of the entities or network objects associated with each identified application. In some embodiments, identified applications include properties of the application, which may be propagated to the network objects which make up the application. The input module 304 may receive data from the various data sources at predetermined time intervals.

The input module 304 may receive network traffic data from the flow source discovery system 234. In some embodiments, the input module 304 may receive a real-time view of the network traffic of the enterprise network and allow the IT administrator to determine the causes of slow-flowing networks. Network traffic data may include a source IP address, a destination IP address, and statistics or metrics regarding the network traffic, including next-hop address, number of bytes, and the duration of the communication.

The input module 304 may receive a selection of a network object or metric when a user interacts with the user interface provided by the reporting module 316. In some embodiments, the input module 304 may receive from the user of the in-context dashboard system 236 user identifiers.

In step 404, the analysis module 306 may analyze a list of network applications received from the application discovery system 232 and the network traffic data received from the flow source discovery system 234 to identify metrics associated with network objects. Once identified, the analysis module 306 may send a request to the metric and object datastore 318 to create or update one or more metric and object data entries stored in the metric and object datastore 318. The metric and object datastore 318 may store a historical record of one or more metrics of the enterprise network 206.

In step 406, the analysis module 306 may analyze a list of network applications received from the application discovery system 232 and the network traffic data received from the flow source discovery system 234 to identify network objects of the enterprise network. Once identified, the analysis module 306 may send a request to the metric and object datastore 318 to create or update one or more metric and object data entries stored in the metric and object datastore 318. Each network object may be associated with multiple metrics. Network objects include physical and virtual objects of the network which communicate with each other by receiving, sending, and transmitting data. Network objects of the enterprise network may include but are not limited to virtual machines (VMs), hosts, applications, servers, routers, switches, storage devices, and applications.

In step 408, the subset module 308 identifies an object subset for each of the identified network objects of the enterprise network. Network objects in the object subset for a particular network object are network objects that are related to the particular objects by communication or performance of similar functions. VMs on the same hypervisor may be in the same object subset.

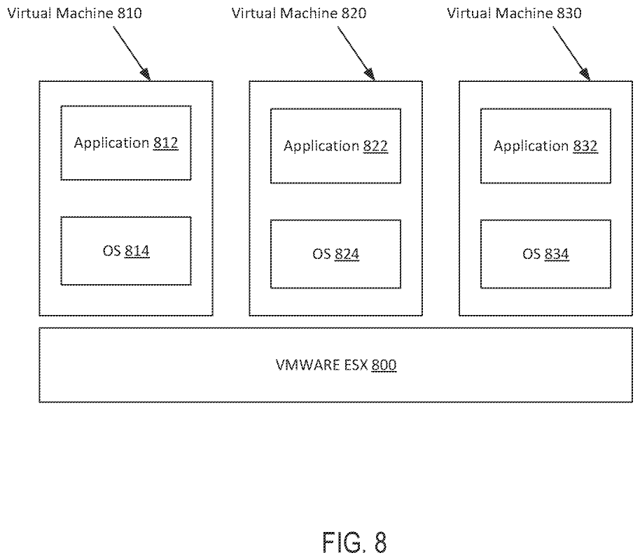

For example, an object subset for a virtual machine 810 of FIG. 8 may include an application 812, an OS 814, a hypervisor 800, a virtual machine 820, and a virtual machine 830. The hypervisor 800 is a virtual machine monitor (VMM) that may host virtual machines 810, 820, and 830. Each of the virtual machines may include their respective application running on an operating system (OS). The virtual machine 810 includes an application 812 and an OS 814. The virtual machine 820 includes an application 822 and OS 824. The virtual machine 830 includes an application 832 and OS 834. In some embodiments, the hypervisor 800 may be an Elastic Sky X (ESX) host.

In step 410, the subset module 308 periodically determines the object subset for one or more of the identified network objects of the enterprise network. In some embodiments, the subset module 308 may determine the object subset when the input module 304 receives data from the various data sources.

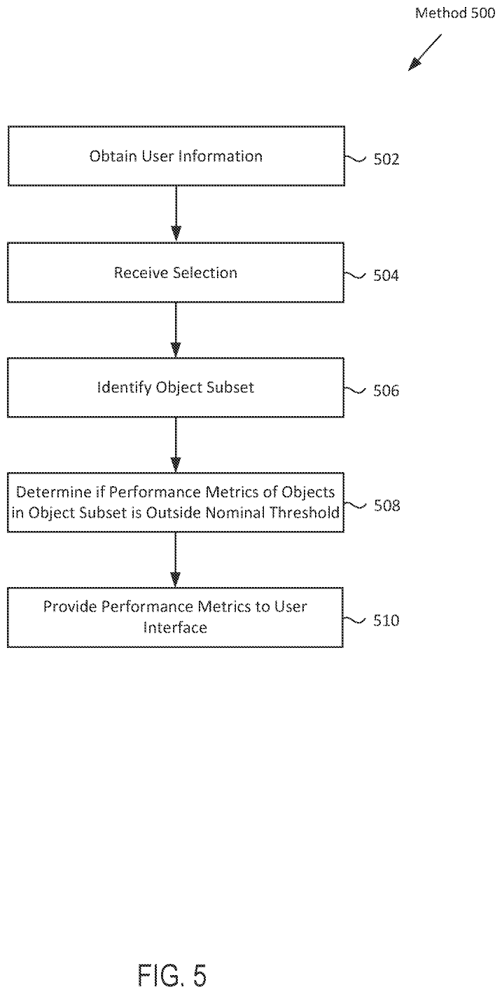

FIG. 5 depicts a flowchart of a method 500 of providing an in-context dashboard according to some embodiments. In step 502, the input module 304 may receive user identification information via a user interface. The user identification may include a user's login and password. In some embodiments, the user may provide identification information in many ways, including but not limited to fingerprint, facial recognition, and other biometrics.

In response to receiving the user's identification information and authenticating the user, the analysis module 306 may optionally send a request to the profile module 310 to provide a user profile associated with the user. The user profile may include information such as the company position of the user in the enterprise network, a history of metrics the user has interacted with in the past. This information may be used to identify metrics which the user may want to see. For example, if the user is a Compute admin, or an administrator in charge of compute devices of the enterprise network such as hosts, hypervisors, VMWARE ESX, and the like, the in-context dashboard system 236 may provide a Compute-centric report and focus metrics on hosts, virtual hosts, network adapters, and relate network objects.

In step 504, the input module 304 receives a selection of a network object or metric from the user. The user may interact with a topological view of a part of the enterprise network to select one or more network objects. In some embodiments, the user interface may provide a field for the user to input a search query. The input module 304 may receive the search query from the user. The selection of the network object or meter may provide context into metrics that the user may be interested in viewing.

In step 506, the analysis module 306 may receive the selection of the network object or metric from the user and identify the network object or metric associated with the user's selection. The selection may be received from a network topology of the enterprise network or may be a result of a search query. Once the network object has been identified, the subset module 308 may identify an object subset associated with the identified network object. In some embodiments, the subset module 308 may determine a particular network object's subset by sending a request to the metric and object datastore 318. The data entries in the metric and object datastore 318 include a network object identifier associated with network objects in the particular network object's object subset.

For example, data entries associated with virtual machine 830 of FIG. 8 may include network object identifiers associated with virtual machine 830. virtual machine 810, virtual machine 820, an application 832, and an OS 834, which represent network objects in virtual machine 830's object subset.

In another example, if the user is a compute admin, the analysis module 306 may prioritize CPU and memory over storage and latency, and network latency may be given a lower priority. If the selected network object is a compute device, then analysis module 306 may send a request to the event module 312 to determine if any events of interest or alarm events have been triggered on the network object. If the CPU usage is high, then CPU usage is prioritized. The breakdown metrics, which may factor in the CPU usage, such as system usage or user usage, may also be prioritized. If the CPU usage is low, then a total CPU usage metric may be prioritized. After analyzing the CPU usage, other metrics associated with storage and latency may be analyzed.

After the object subset has been identified, step 508 may proceed. In this step, the analysis module 306 may send a request to the event module 312 to determine or identify events of interest or alarm events associated with one or more metrics associated with network objects in the identified object subset. An event of interest is triggered when a particular metric is outside a nominal range but not quite in a range that triggers an alarm. An event of interest may be a pre-alarm, alerting the user of a potential problem with the enterprise network. In some embodiments, a range between the nominal threshold and an alarm threshold may be a gray area outside the nominal, everything-is-okay range. In one example, an event of interest may be triggered when a particular metric is within a nominal range.

An example of these ranges and thresholds may be seen in FIG. 7. FIG. 7 includes a line graph 700, which depicts various thresholds and ranges. An upper nominal threshold 710 and a lower nominal threshold 720 may represent a nominal range for a particular metric associated with a particular network object of the enterprise network. The same metric may have different thresholds and ranges depending on the properties of the network object it is associated with. For example, if a metric, such as an incoming byte count for a router, is in a range between the upper nominal threshold 710 and lower nominal threshold 720. In some embodiments, the nominal range may represent a range to which the metric is at an acceptable measure.

An alarm threshold 730 may represent a boundary beyond which the metric has reached an unacceptable measure. When a particular metric exceeds the alarm threshold 730, an alarm criterion may be satisfied, and an alarm event may be triggered. Similar to the upper nominal threshold 710 and lower nominal threshold 720, the alarm threshold 730 for the same metric may be different depending on the properties of the network object associated with the alarm threshold.

An event of interest range 740 may occupy an area of the line graph 700 between the upper nominal threshold 710 and alarm threshold 730. When a particular metric falls within the thresholds, an event of interest criterion may be satisfied, and an event of interest alarm may be triggered. When an event of interest alarm may represent a pre-alarm, or “caution” indicator that the user should be aware of a potential problem with one or more network objects because a particular metric fell into this range.

In some embodiments, an event of interest range 742 may occupy an area of the line graph 700 between lower nominal threshold 720 and an optional lower alarm threshold 760. Similar to the interest range 740, an event of interest alarm may be triggered when the particular metric falls in the interest range 742. In various embodiments, an event of interest alarm is triggered when the particular metric falls below the optional lower alarm threshold 760.

In some embodiments, the thresholds and ranges seen in line graph 700 may be boundaries or limits for a particular metric. In various embodiments, the thresholds and ranges seen in line graph 700 may be boundaries or limits of a result of analysis of a metric. For example, line graph 700 may depict the temporal results of a running average of the incoming byte count or a plot of the maximum value over a time interval of the incoming byte count. In some embodiments, the analysis may be performed on multiple metrics on one or more network objects. For example, an event of interest is triggered when the CPU of a host is out of the nominal range, whether by triggering an event of interest or an alarm, and disk usage of a VM operating on the host is also outside the nominal range.

The analysis module 306 may utilize the user's selection of a network object or metric, along with the identified network object subset or events of interest determined by the event module 312 to identify the top 10 metrics to provide to the user.

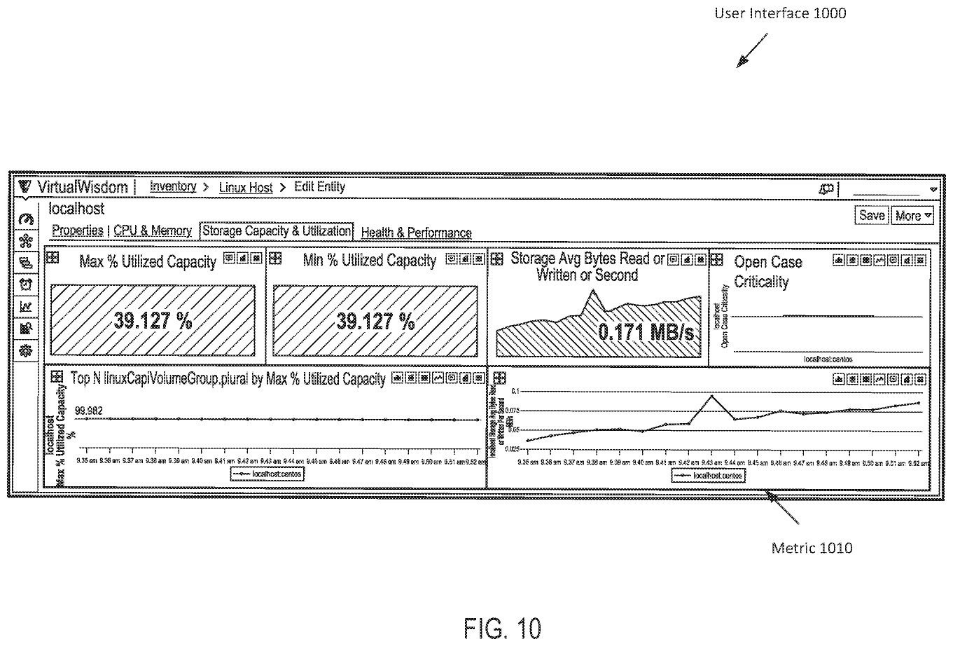

In step 510, the reporting module 316 may provide a predetermined number of “top” metrics identified by the event module 312 to a user interface. The metrics may be presented in the form of a graph, a chart, or a table. An example user interface may be seen in user interface 1000 of FIG. 10. The user interface 1000 may group metrics by functional groups. For example, the user interface 1000 groups some metrics into storage capacity and utilization functionality.

As discussed herein, if some or all of the objects are acting normally or are within nominal thresholds, the in-context dashboard system may provide notification (through the in-context dashboard) to the user to indicate that objects related to the selections of the user are performing as expected and/or nominally (e.g., within nominal thresholds). This information may be helpful by providing the user fast notice that related components are acting normally without the user wasting time considering related components and confirming that the components are behaving normally. Further, there is an improvement in computational efficiency and scaling by providing information of related components (whether acting within nominal ranges or worthy of indication that the components are behaving abnormally) without the user specifically requesting additional information for each component. In this example, by providing an indication that related components or objects are behaving nominally (e.g., as expected when compared to history and/or performance thresholds), the user may consider external factors that relate to performance, easily verify and confirm functions of the network are performing as expected, prepare reports that performance is as expected, and/or provide a record of compliance.

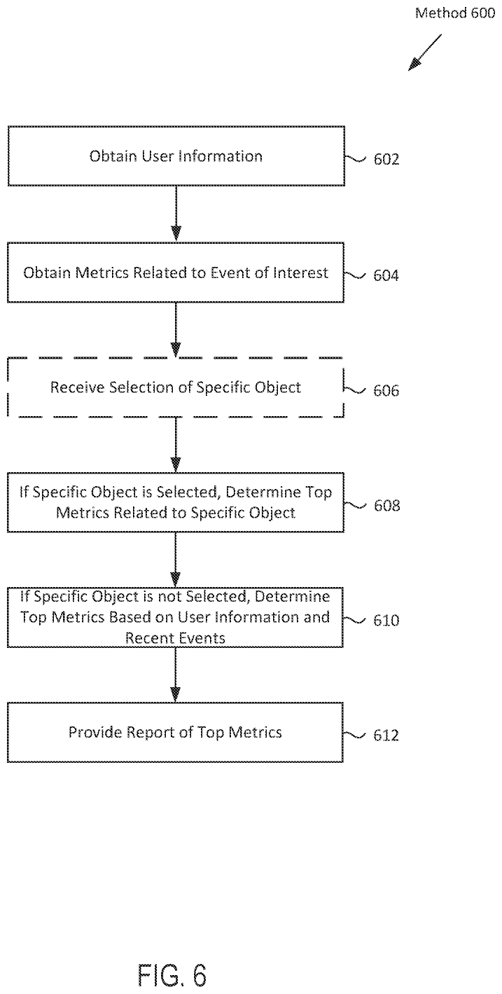

FIG. 6 depicts a flowchart of a method 600 of providing an in-context dashboard according to some embodiments. In step 602, the input module 304 may receive user identification information via a user interface. The user identification may include a user's login and password. In some embodiments, the user may provide identification information in many ways, including but not limited to fingerprint, facial recognition, and other biometrics.

In step 604, the analysis module 306 may send a request to the event module 312 to determine or identify any events outside the nominal range, either event of interest or alarm events triggered in a predetermined period of time before the input module 304 received the user identification information. For example, the event module 312 may compile a list of metrics that triggered an event of interest or an alarm event in the previous 24 hours or since the last time the user logged onto the in-context dashboard system 236. The analysis module 306 may categorize or prioritize metrics that triggered an event of interest or an alarm event based on prioritization factors such as properties of the network object(s) associated with the metric which triggered the event. For example, an event of interest associated with a network object with a higher tier of service may be prioritized over another event of interest associated with another network object with a lower tier of service.

In some embodiments, prioritization factors include the frequency with which the event was triggered. For example, one metric associated with an event of interest that has only been triggered once in the past week may be given a lower priority than another metric associated with another event of interest that has been triggered more than ten times in the past week. In another example, one metric associated with an event of interest that has only been triggered once in the past week may be given a higher priority than another metric associated with another event of interest that has been triggered more than ten times in the past week.

In response to receiving the user's identification information and/or authenticating the user, the analysis module 306 may send a request to the profile module 310 to provide a user profile associated with the user. In some embodiments, the prioritization factors include data from the user profile associated with the authenticated user. The user profile may include information such as the company position of the user in the enterprise network, a history of metrics the user has interacted with in the past. This information may be used to identify metrics which the user may want to see. For example, if a user is a storage administrator that monitors the storage and retrieval of data for an enterprise. The in-context dashboard system 236 may provide storage-centric reports focusing on metrics from storage arrays, fiber channel, Internet Small Computer Systems Interface (iSCSI), and other storage components. The top 10 metrics, as prioritized by one or more of the prioritization factors.

In optional step 606, the input module 304 receives a selection of a network object or metric from the user. The user may interact with a topological view of a part of the enterprise network to select one or more network objects. In some embodiments, the user interface may provide a field for the user to input a search query. The input module 304 may receive the search query from the user. The selection of the network object or meter may provide context into metrics that the user may be interested in viewing.

In step 608, if the input module 304 receives a selection of a network object from the user, then the analysis module 306 will determine or identify an object subset for the selected network object (e.g., one or more object subsets that the selected object belongs). In some embodiments, the subset module 308 may determine a particular network object's subset by sending a request to the metric and object datastore 318. The data entries in the metric and object datastore 318 include a network object identifier associated with network objects in the particular network object's object subset. The analysis module 306 may determine events of interest or alarm events of network objects in the object subset for the selected network object and prioritize those events of interest or alarm events over other events of interest or alarm events identified in step 604.

In some embodiments, an event of interest may be triggered for a particular network object when an alarm or event is triggered for a nearby or neighboring network object if an alarm or event of interest may be triggered in one network object when another network object, which is in communication or performs a similar function as the one network object, triggers an alarm or event of interest. For example, if the CPU usage of the virtual machine 810 increases in a short period of time, and the read speed of the application 822 of virtual machine 820 is steadily decreasing, the analysis module 306 may trigger an event of interest alarm.

In some embodiments, metrics may be filtered and selected based on metrics that the selected network object supports, which may be prioritized over metrics not supported by the selected network object. In various embodiments, input/output operations per second (IOPS) and Errors may be prioritized over byte read metrics. In some embodiments, virtual or derived metrics may be prioritized over base metrics which the derived metrics rely on. For example, a total of any error may be prioritized over the failure to communicate (FC) error or Network-attached Storage (NAS) errors independently.

If the input module 304 receives a selection of a metric from the user, then the analysis module 306 will determine or identify similar metrics associated with events of interest or alarm events identified in step 604. For example, if the user selected the metric total port error rate for host ports. The input module 304 may utilize this information and prioritize event of interest or alarm events in which the total port error rate is at least a criterion of the event of interest or alarm event.

In step 610, if the user does not provide a selection of a network object or metric from the user, the analysis module 306 determines the top 10 metrics based on the user profile and prioritization factors. In some embodiments, if the number of alarm events or events of interest is less than a predetermined number, the analysis module 306 may prioritize high-level aggregate metrics to provide a general sense of the performance of the enterprise network to the user. For example, metrics such as an aggregate or total CPU usage may be prioritized over a breakdown of metrics that may play a factor in the total CPU usage, such as user CPU usage, system CPU usage, and IO Wait metrics.

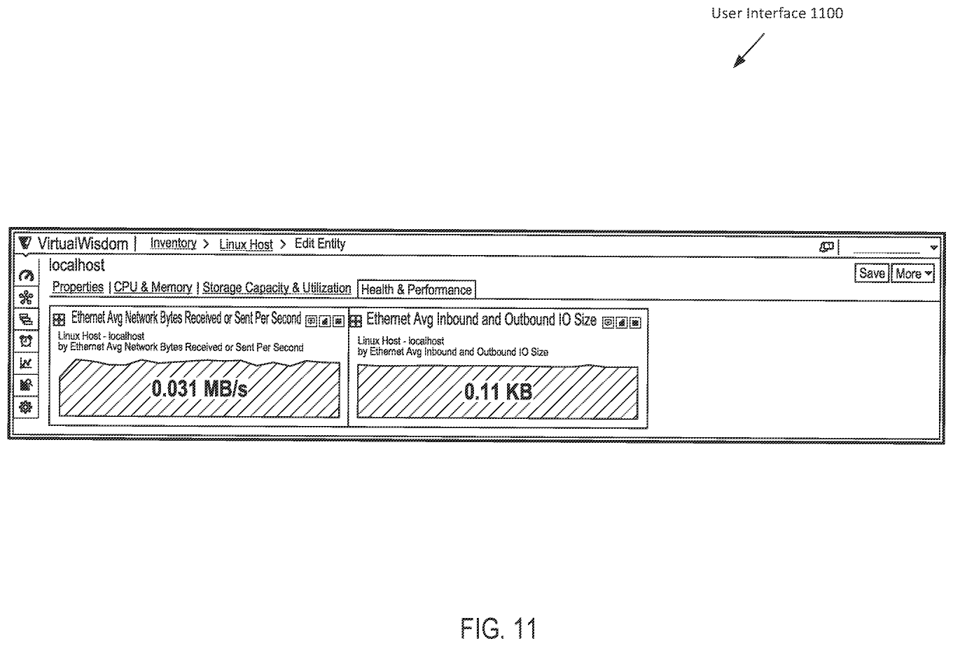

In step 612, the reporting module 316 may provide the top 10 metrics identified by the event module 312 to a user interface. The metrics may be presented in the form of a graph, a chart, or a table. When a user interacts with a particular metric, the analysis module 306 may re-prioritize the top 10 metrics based on the selection of the user. For example, if the user is provided metrics associated with application 812 being executed on the virtual machine 810 of FIG. 8, and the user interacts with the graph associated with the application read speed of the application 812, the reporting module 316 may provide a user interface 1100 of FIG. 11 which focuses on the health and performance of the virtual machine 810 and the hypervisor 800, the host it is being executed on. In various embodiments, the reporting module 316 may provide metrics in a particular form based on the user.

FIG. 13 is a block diagram illustrating entities of an example machine able to read instructions from a machine-readable medium and execute those instructions in a processor to perform the machine processing tasks discussed herein, such as the engine operations discussed above. Specifically, FIG. 13 shows a diagrammatic representation of a machine in the example form of a computer system 1300 within which instructions 1324 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web application, a network router, switch or bridge, or any machine capable of executing instructions 1324 (sequential or otherwise) that specify actions to be taken by that machine. Further, while only a single machine is illustrated, the term “machine” shall also be taken to include any collection of machines that individually or jointly execute instructions 1324 to perform any one or more of the methodologies discussed herein.

The example computer system 1300 includes a processor 1302 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1304, and a static memory 1306, which are configured to communicate with each other via a bus 1308. The computer system 1300 may further include a graphics display unit 1310 (e.g., a plasma display panel (PDP), a liquid crystal display (LCD), a projector, or a cathode ray tube (CRT)). The computer system 1300 may also include an alphanumeric input device 1312 (e.g., a keyboard), a cursor control device 1314 (e.g., a mouse, a trackball, a joystick, a motion sensor, or other pointing instrument), a data store 1316, a signal generation device 1318 (e.g., a speaker), an audio input device 1326 (e.g., a microphone) and a network interface device 1320, which also are configured to communicate via the bus 1308.

The data store 1316 includes a machine-readable medium 1322 on which is stored instructions 1324 (e.g., software) embodying any one or more of the methodologies or functions described herein. The instructions 1324 (e.g., software) may also reside, completely or at least partially, within the main memory 1304 or within the processor 1302 (e.g., within a processor's cache memory) during execution thereof by the computer system 1300, the main memory 1304 and the processor 1302 also constituting machine-readable media. The instructions 1324 (e.g., software) may be transmitted or received over a network (not shown) via network interface 1320.

While machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., instructions 1324) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent some embodiments, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 13. Alternatively, hardware or software modules may be stored elsewhere within a computing system.

As referenced herein, a computer or computing system includes hardware elements used for the operations described here regardless of specific reference in FIG. 13 to such elements, including for example one or more processors, high speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A system comprising:
one or more processors;
memory containing instructions configured to control the one or more processors to:
receive network data related to objects of an enterprise system, the network data being received from a plurality of enterprise monitoring systems, each object being a digital device, a virtual machine, virtual device, or application;
analyze the received network data to identify performance metric data related to any number of objects of the enterprise system, the performance metric data indicating performance of the any number of objects in real time;
receive, from a user interface, a selection of an object identifier of an enterprise system, the object identifier identifying a first object of the objects of the enterprise network;
identify an object subset that includes the object identifier, the object subset including some objects of the enterprise network that are related to each other by communication or performance of similar functions; and
if performance metrics from the network data for any of the objects in the object subset are performing outside of nominal thresholds, provide at least some performance metric data to the user interface regarding those objects in the object subset.

2. The system of claim 1, wherein performance metric data includes performance information received from the enterprise monitoring system.

3. The system of claim 1, wherein performance metric includes analysis of performance metric data received from the enterprise monitoring system.

4. The system of claim 1, wherein when performance metrics from the network data for any of the objects in the object subset are performing outside of nominal thresholds comprises changes in metric parameters over time are outside of a nominal threshold.

5. The system of claim 1, wherein the performance metrics from the network data for any of the objects in the object subset includes an analysis of performance metrics, when a result of the analysis is performing outside of nominal threshold, provide at the result of the analysis to the user interface regarding the first object.

6. The system of claim 1, wherein the performance metrics performing outside of nominal thresholds may be two or more performance metrics for the same object of the enterprise network.

7. The system of claim 1, wherein at least one of the nominal thresholds changes dynamically.

8. The system of claim 1, wherein at least one of the nominal thresholds is received from the user interface.

9. The system of claim 1, wherein the instructions are further configured to control the one or more processors to, if performance metrics from the network data for all of the objects in the object subset are performing within nominal thresholds, provide an indication that the objects are performing nominally.

10. A method comprising:
receiving network data related to objects of an enterprise system, the network data being received from a plurality of enterprise monitoring systems, each object being a digital device, a virtual machine, virtual device, or application;
analyzing the received network data to identify performance metric data related to any number of objects of the enterprise system, the performance metric data indicating performance of the any number of objects in real time;
receiving, from a user interface, a selection of an object identifier of an enterprise system, the object identifier identifying a first object of the objects of the enterprise network;
identifying an object subset that includes the object identifier, the object subset including some objects of the enterprise network that are related to each other by communication or performance of similar functions; and
if performance metrics from the network data for any of the objects in the object subset are performing outside of nominal thresholds, providing at least some performance metric data to the user interface regarding the those objects in the object subset.

11. The method of claim 10, wherein performance metric data includes performance information received from the enterprise monitoring system.

12. The method of claim 10, wherein performance metric includes analysis of performance metric data received from the enterprise monitoring system.

13. The method of claim 10, wherein when performance metrics from the network data for any of the objects in the object subset are performing outside of nominal thresholds comprises changes in metric parameters over time are outside of a nominal threshold.

14. The method of claim 10, wherein the performance metrics from the network data for any of the objects in the object subset includes an analysis of performance metrics, when a result of the analysis is performing outside of nominal threshold, provide at the result of the analysis to the user interface regarding the first object.

15. The method of claim 10, wherein the performance metrics performing outside of nominal thresholds may be two or more performance metrics for the same object of the enterprise network.

16. The method of claim 10, wherein at least one of the nominal thresholds changes dynamically.

17. The method of claim 10, wherein at least one of the nominal thresholds is received from the user interface.

18. The method of claim 10, further comprising if performance metrics from the network data for all of the objects in the object subset are performing within nominal thresholds, providing an indication that the objects are performing nominally.

19. A computer program product comprising a non-transitory computer readable storage medium having a program code embodied therewith, the program code executable by a computing system to cause the computing system to perform:
receiving network data related to objects of an enterprise system, the network data being received from a plurality of enterprise monitoring systems, each object being a digital device, a virtual machine, virtual device, or application;
analyzing the received network data to identify performance metric data related to any number of objects of the enterprise system, the performance metric data indicating performance of the any number of objects in real time;
receiving, from a user interface, a selection of an object identifier of an enterprise system, the object identifier identifying a first object of the objects of the enterprise network;
identifying an object subset that includes the object identifier, the object subset including some objects of the enterprise network that are related to each other by communication or performance of similar functions; and
if performance metrics from the network data for any of the objects in the object subset are performing outside of nominal thresholds, providing at least some performance metric data to the user interface regarding the those objects in the object subset.
